(19) United States
(12) Patent Application Publication
(10) Pub. No.: US 2011/0013391 A1
(43) Pub. Date: Jan. 20, 2011

(54) LIGHT EMITTING DIODE (LED) MARKING PANEL

(76) Inventor: Yi-Qun CHEN, Taichung City (TW)

Correspondence Address: EGBERT LAW OFFICES, 412 MAIN STREET, 7TH FLOOR, HOUSTON, TX, 77002, US

(21) Appl. No.: 12/504,615

(22) Filed: Jul. 16, 2009

(51) Int. Cl. F21V 1/00; F21V 21/00

(52) U.S. Cl. 362/235; 362/249.02; 257/98

(57) ABSTRACT

The present invention provides a light emitting diode (LED) marking panel, including a substrate, which forms a marking surface; a protruding flange, which is protruded on the periphery of the marking surface of the substrate; and a recessed space is formed internally onto the protruding flange. Multiple LED units are arranged at intervals on the marking surface of the substrate and electrically connected via conductor wire. A transparent waterproof layer is formed by a transparent waterproof agent that is filled into the recessed space of the protruding flange. A chromogenic layer, attached onto the transparent waterproof layer, is defined with preset shape and color, such that the light emitted from LED units can pass through it. The LED units and conductor wire feature excellent waterproofing with the covering of the transparent waterproof layer, and the LED marking panel can be used more robustly and durably with much longer service life.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light emitting diode (LED) marking panel, and more particularly to an innovative marking panel which allows LED units and conductor wire to be fully covered and protected by a transparent waterproof layer.

2. Description of Related Art Including Information Disclosed Under 37 CFR 1.97 and 37 CFR 1.98

The LED marking panel of the present invention, also called an LED designation plate, is structurally characterized by LED units arranged at intervals on the surface of the marking panel in marked patterns. The LED units are attached onto the surface and electrically interconnected by wires. Such an LED marking panel is widely applied as a traffic sign due to its advantages such as simple construction and energy saving.

However, it is found from actual application that the LED units, along with the wire, are surface-mounted onto the marking panel and exposed to harsh weather, such as strong wind, sunlight and rainfall, leading probably to damage, peeling, breakage and short-circuit of units and shorter service life of the typical LED marking panel.

Moreover, a lamphouse LED marking panel has been developed without the disadvantage of exposure. However, the lamphouse structure made of several lateral plates is generally massive and heavy, and also difficult for waterproofing, thus increasing greatly the cost of materials and load of the support.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, the LED marking panel is mainly composed of a substrate, LED units, a transparent waterproof layer and a chromogenic layer. The LED units and conductor wire can be fully covered by the transparent waterproof layer, so the present invention features excellent waterproofing and stronger resistance to collision and weathering. Moreover, the LED marking panel of the present invention can be used more robustly and durably with a much longer service life.

Based on the unique present invention, the LED marking panel is mainly composed of a substrate, LED units, a transparent waterproof layer and a chromogenic layer. The present invention presents better thin-profile, lightweight and waterproofing effect, so it is suitable for large or small marking products as compared to the prior art.

There are improvements brought about by this invention.

Based on the structure of the present invention, a reflective membrane is placed between the transparent waterproof layer and the chromogenic layer. Reflective and shiny effects can be yielded in response to the injected ray for further improving the marking and alarming effect of the LED marking panel.

Based on the structure of the present invention, the LED marking panel comprises a covering member. The defective LED units of the LED marking panel can be covered for repair or replacement. Since LED units of the LED marking panel are permanently covered by the transparent waterproof layer, said covering member will provide an easy-to-operate method of repairing the defective units with good visual effect.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows an exploded perspective view of the preferred embodiment of the present invention.

FIG. 3 shows an assembled sectional view of the preferred embodiment of the present invention.

FIG. 4 shows an exploded perspective view of another preferred embodiment of the present invention.

FIG. 5 shows an assembled sectional view of another preferred embodiment of the present invention.

FIG. 6 shows a top plan view of another preferred embodiment of the present invention.

FIG. 7 shows a schematic view of an application of the present invention with a covering member attached onto the surface of the chromogenic layer.

### DETAILED DESCRIPTION OF THE INVENTION

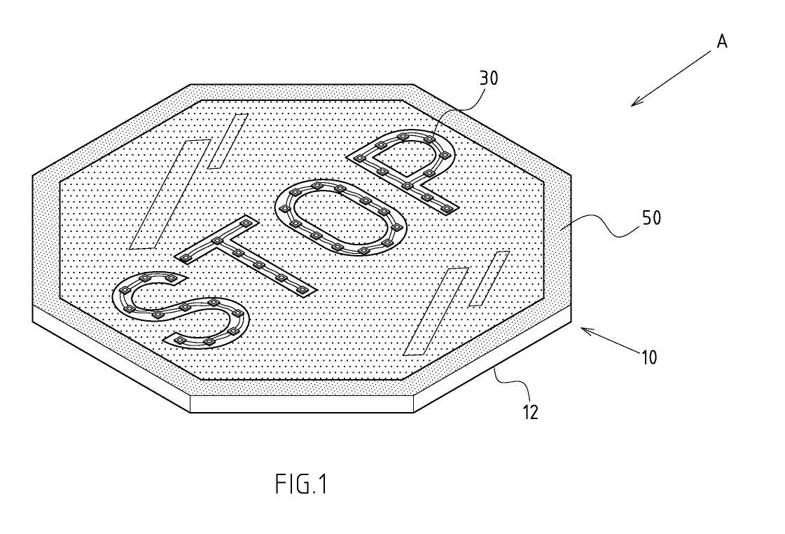

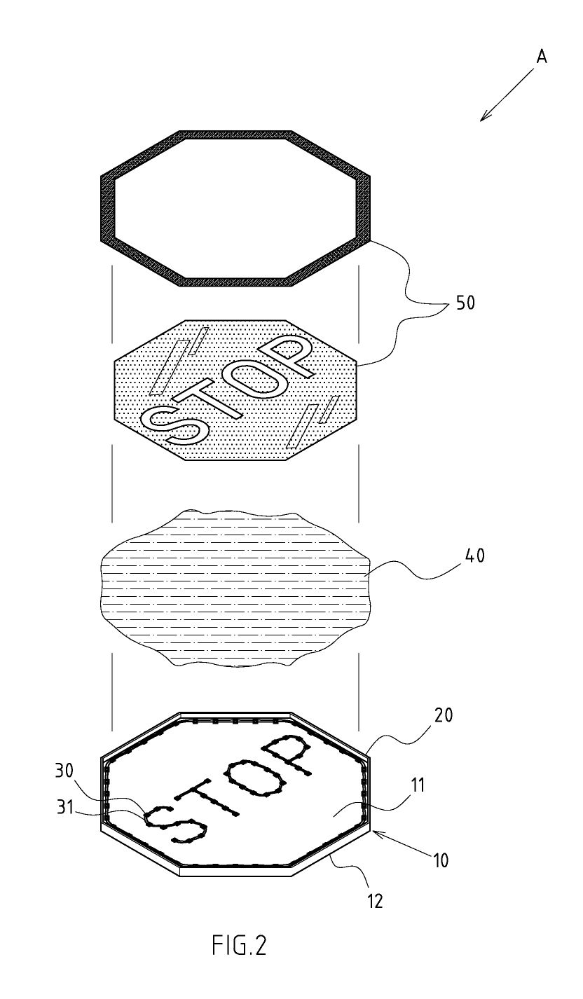

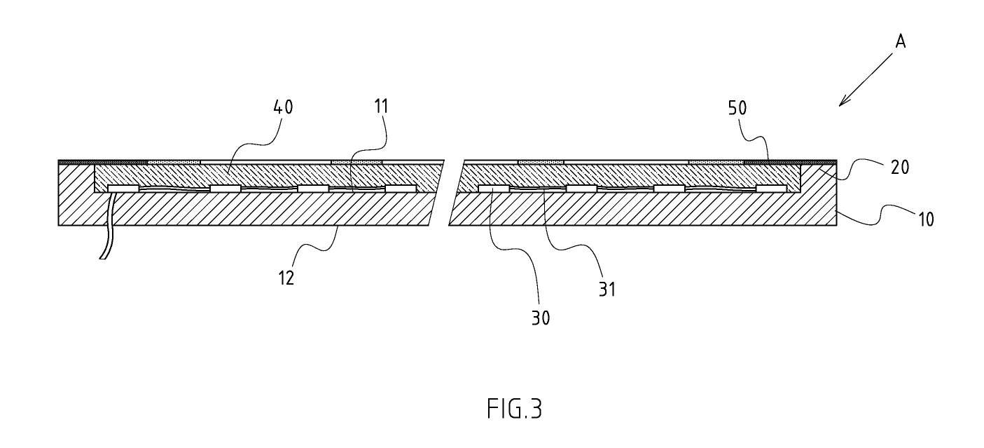

FIGS. 1-3 depict preferred embodiments of an LED marking panel of the present invention. The embodiments are provided for only explanatory objectives with respect to the patent claims.

The LED marking panel A comprises a substrate 10, which is a plate of certain thickness and geometry used to define a marking surface 11 and a back surface 12.

The marking panel A includes a protruding flange 20, which is protruded on the periphery of the marking surface 11 of the substrate 10. A recessed space is formed on the marking surface 11 of the protruding flange 20.

Multiple LED units 30 are arranged at intervals on the marking surface 11 of the substrate 10 and electrically connected via conductor wire 31.

A transparent waterproof layer 40 is formed by a transparent waterproof agent that is filled into the recessed space of the protruding flange 20 and then hardened. The transparent waterproof layer 40 fully covers LED units 30 and conductor wire 31, but the light emitted from LED units 30 can still be released from the transparent waterproof layer 40. The transparent waterproof layer 40 is flushed with the protruding flange 20.

A chromogenic layer 50 is attached onto the transparent waterproof layer 40. The chromogenic layer 50 of light transmission is defined with preset shape and color, such that the light emitted from LED units 30 can pass through it. The chromogenic layer 50 is made of colored self-adhesive.

Based on above-specified structure, the LED marking panel A of the present invention is characterized by a protruding flange 20 formed around the marking surface 11 of the substrate 10 to define a recessed space for accommodating the transparent waterproof layer 40 and fully covering LED units 30 and conductor wire 31. As both the transparent waterproof layer 40 and chromogenic layer 50 present the property of light transmission, the light emitted from LED units 30 can still be dispersed after passing through the transparent waterproof layer 40 and chromogenic layer 50. The LED units 30 and conductor wire 31 feature excellent waterproofing, and stronger resistance to collision and weathering with the covering of the transparent waterproof layer 40.

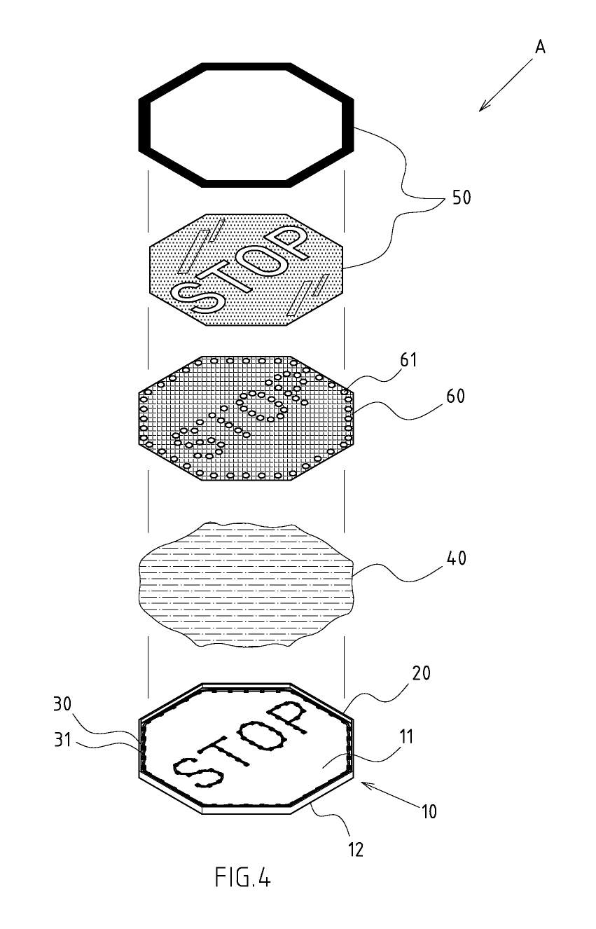

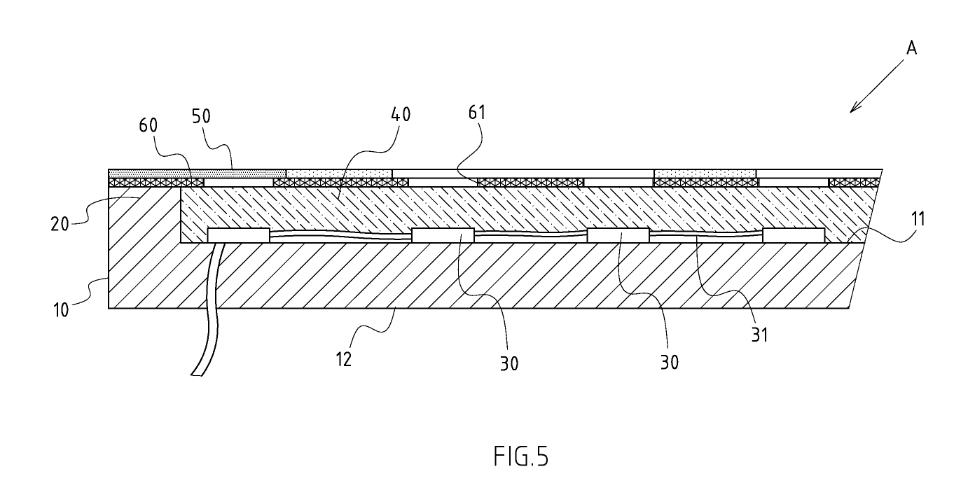

The chromogenic layer 50 is made of colored and transparent reflective paper, thus generating reflective and shiny effects in response to injected ray. Referring to FIGS. 4 and 5, a non-transparent reflective membrane 60 is placed between the transparent waterproof layer 40 and the chromogenic layer 50, so that reflective and shiny effects can be yielded in response to the injected ray for further improving the marking and alarming effect of the LED marking panel A. Moreover, since the reflective membrane 60 is made of non-transparent materials, through-holes 61 (or spacings) are opened correspondingly to the LED units 30 for the purpose of light penetration.

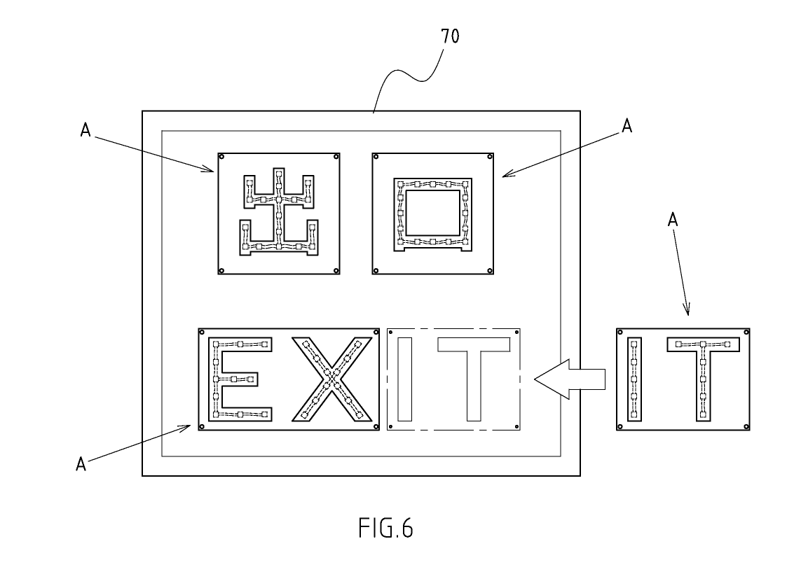

Referring also to FIG. 6, another preferred embodiment of the present invention, several LED marking panels A can be arranged and positioned (via bolts) onto a large-sized substrate 70, e.g. a large-sized traffic sign on the expressway. Owing to huge area, every character can be fabricated into a group of LED marking panels A, which are then arranged and positioned onto a large-sized substrate 70 to form a large-sized marking panel.

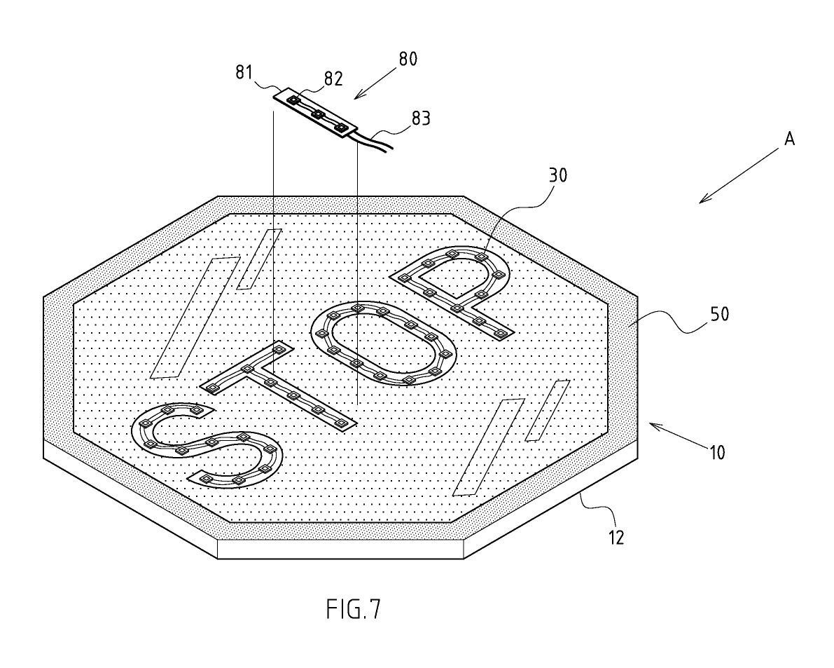

Referring also to FIG. 7, the LED marking panel A also contains a covering member 80, which comprises a shroud 81, LED units 82 and supply lines 83 set on the surface of the shroud 81. The covering member 80 is attached securely onto the surface of the chromogenic layer 50, and the color of the shroud 81 is defined as the same with that of the mended portion of the chromogenic layer 50. With the arrangement of the covering member 80, the defective LED units 30 of the LED marking panel A can be covered for repair or replacement. Since LED units 30 of the LED marking panel A are permanently covered by the transparent waterproof layer 40, said covering member 80 will provide an easy-to-operate method of repairing the defective units with good visual effect.

1. A light emitting diode (LED) marking panel, comprising:
a substrate, being comprised of a plate with a thickness and a shape defining a marking surface and a back surface;
a protruding flange, being protruded on a periphery of the marking surface of the substrate;
a recessed space formed on the marking surface of the protruding flange;
a plurality of LED units, arranged at intervals on the marking surface of the substrate, and electrically connected via conductor wire;
a transparent waterproof layer, being formed by a transparent waterproof agent filled into the recessed space of the protruding flange, said transparent waterproof layer fully covering the LED units and conductor wire, light emitted from LED units being released from the transparent waterproof layer; and
a chromogenic layer, attached onto the transparent waterproof layer and defined with preset shape and color, the light emitted from LED units passing through the chromogenic layer.

2. The marking panel defined in claim 1, wherein the transparent waterproof layer is flushed with the protruding flange.

3. The marking panel defined in claim 1, wherein the chromogenic layer is comprised of colored self-adhesive.

4. The marking panel defined in claim 1, wherein the chromogenic layer is comprised of colored and transparent reflective paper.

5. The marking panel defined in claim 1, further comprising:
a non-transparent reflective membrane placed between the transparent waterproof layer and the chromogenic layer, the through-holes being opened on the reflective membrane corresponding to the LED units, the light emitted from LED units passing through the non-transparent reflective membrane.

6. The marking panel defined in claim 1, further comprising:
a covering member, being comprised of a shroud, LED units and supply lines set on the surface of the shroud, the covering member being attached securely onto the surface of the chromogenic layer, defective LED units of the LED marking panel A being covered for repair or replacement.
